(19) United States
(12) Patent Application Publication
(10) Pub. No.: US 2005/0069765 A1
(43) Pub. Date: Mar. 31, 2005

(54) Nonaqueous electrolyte cell

(75) Inventor: Mikiya Yamasaki, Sumoto-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Moriguchi-shi (JP)

(21) Appl. No.: 10/942,142

(22) Filed: Sep. 16, 2004

(30) Foreign Application Priority Data
Sep. 29, 2003 (JP) 2003-337271

(51) Int. Cl. H01M 6/18; H01M 10/40

(52) U.S. Cl. 429/189; 429/309; 429/317; 429/307

(57) ABSTRACT

The present invention provides a non-aqueous electrolyte cell that utilizes lithium manganese oxide, which is cheap, for the positive electrode active material and thus has improved high-temperature cycle characteristics. The non-aqueous electrolyte cell has a positive electrode including lithium manganese oxide as an active material, a negative electrode, and a polymer electrolyte. The polymer electrolyte is a polymerization of a prepolymer included in a prepolymer electrolyte that includes a non-aqueous solvent, an electrolyte salt, and the prepolymer. As the prepolymer, polyester acrylate and/or polyester methacrylate are used.

### BACKGROUND OF THE INVENTION

(1) Field of the Invention

The present invention relates to an improvement of non-aqueous electrolyte cells, and more particularly relates to an improvement of the high-temperature characteristics of non-aqueous electrolyte cells that include lithium manganese oxide as a positive electrode active material.

(2) Description of the Prior Art

In recent years, there has been a rapid reduction in the size and weight of mobile information terminals such as mobile telephones, notebook personal computers, and PDAs (Personal Digital Assistances). Higher capacity is required of cells and batteries serving as the driving power sources of such terminals. Non-aqueous electrolyte cells have high energy density and high capacity, and as such are widely used as the driving and memory-backup power sources for the mobile information terminals. There is even discussion of applying the non-aqueous electrolyte cells to the driving power sources of hybrid and electric vehicles, which require large power output.

As the positive electrode active material for the non-aqueous electrolyte cells, lithium cobalt oxide (LiCoO₂) is often used. Though lithium cobalt oxide excels in its capacity and safety, there is doubt as to stable supply because the reserve of cobalt, which is the main element, is barely adequate and hence expensive.

The use of the non-aqueous electrolyte cells as the driving power sources for heavy machinery requires a stable supply of raw materials of the positive electrode active material. In view of this, the use of manganese, which is cheaper and provides good availability, has been awaited as a substitute for cobalt, which is expensive and provides poor availability.

Lithium manganese oxide (LiMn₂O₄) itself, serving as the positive electrode active material using manganese, excels in safety and thermal stability. However, the lithium manganese oxide can be problematic in that its energy density is lower than that of lithium cobalt oxide and that the manganese is dissolved in the electrolyte when exposed to high temperature conditions.

Techniques proposed in relation to the improvement of the non-aqueous electrolyte include using a polymer solid electrolyte formed by polymerizing polyester acrylate or polyester methacrylate (see, for example, patent documents 1 to 3).
Patent document 1: Japanese Unexamined Patent Publication No. 2000-311516 (Abstract)
Patent document 2: Japanese Unexamined Patent Publication No. 2002-33016 (Abstract)
Patent document 3: Japanese Unexamined Patent Publication No. 2002-33017 (Abstract).
Patent document 1 describes a technique of blending a metal salt of Ia group of the periodic table in a polymer of polyester (meth)acrylate in which at least part of the hydroxyl groups of polyester polyol is converted into (meth)acrylic ester. Thus, patent document 1 tries to obtain a flexible polymer solid electrolyte that has high ion conductivity and electrochemical stability.

Patent document 2 describes a technique of containing a metal salt of Ia group of the periodic table in a polymer compound having an acid anhydride structure, thus trying to obtain a polymer solid electrolyte that has high ion conductivity and that excels in electrochemical stability and in stability under charge conditions.

Patent document 3 describes a technique of containing a compound having an acid anhydride structure and a metal salt of Ia group of the periodic table in a polymer compound, thus trying to obtain a polymer solid electrolyte that has high ion conductivity and that excels in electrochemical stability and in stability under charge conditions.

The techniques described in patent documents 1 to 3, however, are with respect only to the polymer solid electrolyte, and do not take into account the problem of reaction of the polymer solid electrolyte with the electrodes, i.e., the dissolution of the lithium manganese oxide under high temperature conditions. Thus, a further improvement is being awaited in this respect.

### SUMMARY OF THE INVENTION

It is an object of the present invention to improve the high-temperature cycle characteristics of a non-aqueous electrolyte cell that utilizes lithium manganese oxide.

In order to accomplish the above object, a first aspect of the present invention provides the following structure.

1) A non-aqueous electrolyte cell comprising: a positive electrode; a negative electrode; and a polymer electrolyte, wherein: the positive electrode includes lithium manganese oxide as an active material; the polymer electrolyte is a polymerization of a prepolymer included in a prepolymer electrolyte, the prepolymer electrolyte including a non-aqueous solvent, an electrolyte salt, and the prepolymer; and the prepolymer includes polyester acrylate and/or polyester methacrylate.

According to the first aspect, the functional group that is derived from the polyester acrylate and/or polyester methacrylate included in the polymer (polyester-based polymer) formed by polymerizing the polyester acrylate and/or polyester methacrylate (hereinafter referred to as a polyester-based monomer) functions to inhibit the dissolution of the manganese into the electrolyte under high temperatures. This significantly increases the high-temperature cycle characteristics.

2) In the first aspect of the present invention, the prepolymer electrolyte may further include a vinylene carbonate derivative.

According to the second aspect, the vinylene carbonate derivative forms a coating film on the negative electrode surface and thus inhibits the reaction of the non-aqueous solvent and the negative electrode. This further increases the high-temperature cycle characteristics.

3) In the first aspect of the present invention, the prepolymer may include polyether acrylate and/or polyether methacrylate.

4) In the second aspect of the present invention, the prepolymer may include polyether acrylate and/or polyether methacrylate.

According to the third and fourth aspects, the functional group that is derived from the polyether acrylate and/or polyether methacrylate (hereinafter referred to as a polyether-based monomer) included in the polymer electrolyte functions to enhance lithium ion conductivity. This further increases the high-temperature cycle characteristics.

### BRIEF DESCRIPTION OF THE DRAWINGS

FIG. 1 is a front view of a non-aqueous electrolyte cell according to the present invention.

FIG. 2 is a sectional view of a laminate outer casing body used for the non-aqueous electrolyte cell according to the present invention.

FIG. 3 is a perspective view of an electrode body, according to the present invention.

### DESCRIPTION OF THE PREFERRED EMBODIMENTS

Embodiments of the present invention will be described in detail with reference to the drawings. Note that the present invention is not limited to the following embodiments; it should be appreciated that variations are possible within the scope of the invention.

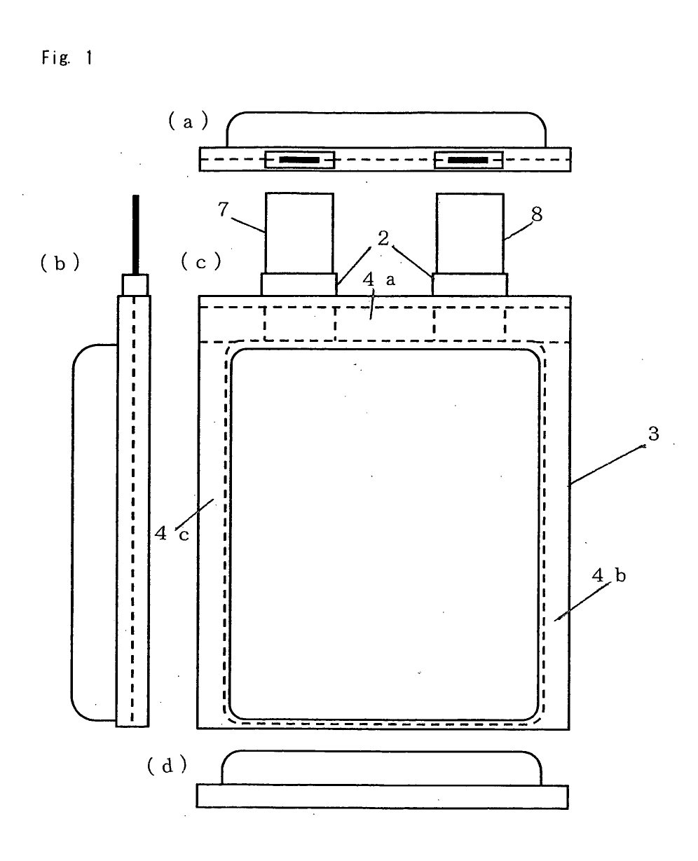

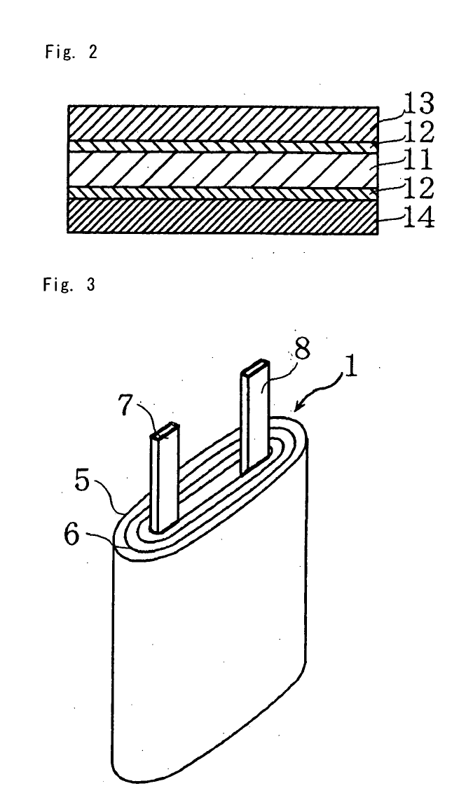

FIG. 1 is a front view of a gelled non-aqueous electrolyte cell using a laminate outer casing body according to the embodiment of the present invention. FIG. 2 is a sectional view of the laminate outer casing body used for the gelled non-aqueous electrolyte cell. FIG. 3 is a perspective view of an electrode body used in the non-aqueous electrolyte cell.

The non-aqueous electrolyte cell of the present invention includes an electrode body shown in FIG. 3 which is placed in the storage space of the laminate outer casing body. As shown in FIG. 1, this storage space is formed by folding a laminate outer casing body 3 in half and sealing the top and both side edges at sealed portions 4a, 4b, and 4c. The storage space includes, as well as the electrode body 1, a polymer electrolyte in which a lithium salt (electrolyte salt) is dissolved in a non-aqueous solvent having a polymer. As shown in FIG. 3, the electrode body 1 is prepared by winding together a positive electrode 5, a negative electrode 6, and a separator (not shown) that separates the positive and negative electrodes into a flat wound shape. The separator is formed of a finely porous film (0.025 mm thick) made of an olefin-based resin, which is cheap and not highly reactive to organic solvents.

The positive electrode 5 is connected to a positive lead 7 made of aluminum, and the negative electrode 6 is connected to a negative lead 8 made of copper. This enables chemical energy generated inside the cell to be extracted externally as electric energy.

As shown in FIG. 2, the laminate outer casing body 3 has a five-layer structure in which a resin layer 13 (nylon), an adhesive layer 12, an aluminum layer 11 (30 μm thick), an adhesive layer 12, and a resin layer 14 (polypropylene) are adhered. It should be noted, however, that the laminate outer casing body 3 is not limited to this structure.

The polymer electrolyte is formed by polymerizing a prepolymer electrolyte including a non-aqueous solvent, an electrolyte salt, and a prepolymer having a polyester-based monomer.

Method of Cell Preparation

A method of preparing the cell to practice the present invention will be described.

Preparation of Positive Electrode

An active material slurry was obtained by mixing 92 parts by mass of a positive electrode active material made of spinel-type lithium manganese oxide (LiMn₂O₄), 5 parts by mass of a conductivity enhancer made of acetylene black, 3 parts by mass of a binder made of polyvinylidene fluoride (PVdF), and N-methyl-2-pyrrolidone (NMP).

This active material slurry was uniformly applied on both sides of a positive electrode substrate made of an aluminum foil of 20 μm thick by a doctor blade, and then was dried by passing it through the inside of a heated dryer. By this drying step, the organic solvent required in the step of preparing the slurry was removed. Subsequently, the electrode plate was rolled with a roll press machine to a thickness of 0.17 mm, and thus, the positive electrode 5 was prepared.

Preparation of Negative Electrode

An active material slurry was prepared by mixing a negative electrode active material made of graphite (d(002)=0.335 nm), a binder made of polyvinylidene fluoride (PVdF), and N-methyl-2-pyrrolidone (NMP). This active material slurry was uniformly applied on both sides of a negative electrode substrate made of a copper foil of 20 μm thick by a doctor blade, and then was dried by passing it through the inside of a heated dryer. By this drying step, the organic solvent required in the step of preparing the slurry was removed. Subsequently, the electrode plate was rolled with a roll press machine to a thickness of 0.14 mm, and thus, the negative electrode 6 was prepared.

Preparation of Prepolymer Electrolyte

A mixture solvent was prepared by mixing ethylene carbonate and diethyl carbonate at a mass ratio of 3:7. LiPF₆ serving as the electrolyte salt was dissolved in this mixture solvent at 1M (mole/liter). Thus, an electrolyte solution was prepared. Fifteen parts by mass of this electrolyte solution was mixed with 1 part by mass of a polymerizable monomer including a polyester-based monomer. One hundred parts by mass of the resulting solution was mixed with 1 part by mass of vinylene carbonate (VC). Further, t-butyl peroxy pivalate serving as a polymerization initiator was added to the solution at 5000 ppm. Thus, the prepolymer electrolyte was prepared.

Preparation of Electrode Body

The positive electrode lead 7 and the negative electrode lead 8 were attached respectively to the positive and negative electrodes, to which a protection tape 2 made of polyphenyl sulfide was further adhered. The electrodes were overlapped with each other with the separator made of a finely porous film (0.025 mm thick) of olefin-based resin between the electrodes. The overlapping was performed in such a manner that the center lines in the width direction of the electrodes would agree. Then, the electrodes were wound with a winding device and the outermost surface was taped. Thus, the flat wound electrode body 1 was prepared.

Cell Assembly

A five-layer laminate material in the form of sheet shown in FIG. 2 was prepared. This aluminum laminate material was folded in half so that the edges and the corners would exactly meet, resulting in top and side edges 4a, 4b, and 4c. The electrode body 1 was inserted into the storage space of the folded aluminum laminate material in such a manner that the positive and negative electrode leads 7 and 8 would protrude from the top edge of the laminate material. The top edge 4a, from which the positive and negative electrode leads 7 and 8 protruded, and the one side edge 4b were welded. The prepolymer electrolyte was injected from the opening that was yet to be welded (the portion corresponding to the sealed portion 4c after sealing the cell), and the sealed portion 4c was then welded. The sealing of each edge was performed with a high-frequency induction welding device.

The monomer was allowed to polymerize while held in a thermostatic chamber of 60° C. for three hours. Thus, the non-aqueous electrolyte cell was prepared.

While in this embodiment the slurry was applied with a doctor blade, a die coater may perform this task. Instead of an active material slurry, an active material paste may be used, which would be applied by the roller coating method. The use of an aluminum mesh provides the same results as when using an aluminum foil.

The present invention will be further detailed with the use of Examples.

### EXAMPLES 1 TO 17, COMPARATIVE EXAMPLES 1 TO 12, REFERENCE EXAMPLES 1 to 3

As shown in Tables 1 and 2, cells were prepared in the same manner as that described above except for changes in the positive electrode active material, the monomer included in the prepolymer, its composition ratio, and the added amount of the vinylene carbonate.

In Comparative Examples 7, 8, 11, and 12, and Reference Example 3, there was no addition of monomer or polymerization initiator, and hence the step of monomer polymerization was not performed in the above process of cell preparation. The cells of Comparative Examples 7, 8, 11, and 12, and Reference Example 3 are therefore not “polymer electrolyte cells,” but “non-aqueous electrolyte cells.”

With the use of the cells of Examples 1 to 17, Comparative Examples 1 to 12, and Reference Examples 1 to 3, high-temperature (60° C.) cycle capacity maintenance rate was measured. The results are listed in Tables 1 and 2.

High-Temperature Cycle Characteristics Tests
1. Charge at 1 I t (700 mA) to 4.2 V, and then at 4.2 V to 35 mA.
2. 10 minutes' intermission.
3. Discharge at 1 I t (700 mA) to 2.75 V.
4. 10 minutes' intermission. Then back to 1.

Capacity maintenance rate (%): (500-cycle discharge capacity÷1-cycle discharge capacity)×100

TABLE 1

| | Positive | Polyester-based | | Polyether-based | | | Capacity |
|---|---|---|---|---|---|---|---|
| | electrode active | monomer | | monomer | | VC | maintenance |
| | material | Monomer 1 | Monomer 2 | Monomer 1 | Monomer 2 | (%) | rate (%) |
| Ex. 1 | LiMn₂O₄ | Formula | Formula | | | — | 75 |
| | | 1: 50 m % | 3: 50 m % | | | | |
| Ex. 2 | LiMn₂O₄ | Formula | Formula | | | — | 76 |
| | | 1: 50 m % | 4: 50 m % | | | | |
| Ex. 3 | LiMn₂O₄ | Formula | Formula | | | — | 76 |
| | | 1: 70 m % | 3: 30 m % | | | | |
| Ex. 4 | LiMn₂O₄ | Formula | Formula | | | — | 76 |
| | | 1′: | 3′: 30 m % | | | | |
| | | 70 m % | | | | | |
| Ex. 5 | LiMn₂O₄ | Formula | Formula | | | — | 77 |
| | | 2: 70 m % | 3: 30 m % | | | | |
| Ex. 6 | LiMn₂O₄ | Formula | Formula | | | 1.0 | 81 |
| | | 1: 70 m % | 3: 30 m % | | | | |
| Ex. 7 | LiMn₂O₄ | Formula | Formula | | | 2.0 | 82 |
| | | 1: 70 m % | 3: 30 m % | | | | |
| Ex. 8 | LiMn₂O₄ | | Formula | Formula | | — | 75 |
| | | | 3: 30 m % | 6: 70 m % | | | |
| Ex. 9 | LiMn₂O₄ | | Formula | Formula | | — | 75 |
| | | | 3: 30 m % | 6′: 70 m % | | | |
| Ex. 10 | LiMn₂O₄ | | Formula | Formula | | — | 74 |
| | | | 3′: 30 m % | 6″: 70 m % | | | |
| Ex. 11 | LiMn₂O₄ | | Formula | Formula | | — | 72 |
| | | | 3: 20 m % | 6: 80 m % | | | |
| Ex. 12 | LiMn₂O₄ | | Formula | Formula | | — | 70 |
| | | | 3: 10 m % | 6: 90 m % | | | |
| Ex. 13 | LiMn₂O₄ | | Formula | Formula | | 1.0 | 80 |
| | | | 3: 30 m % | 6: 70 m % | | | |
| Ex. 14 | LiMn₂O₄: 50 m % | Formula | Formula | | | — | 81 |
| | LiCoO₂: 50 m % | 1: 70 m % | 3: 30 m % | | | | |
| Ex. 15 | LiMn₂O₄: 50 m % | Formula | Formula | | | 1.0 | 84 |
| | LiCoO₂: 50 m % | 1: 70 m % | 3: 30 m % | | | | |
| Ex. 16 | LiMn₂O₄: 50 m % | | Formula | Formula | | — | 80 |
| | LiCoO₂: 50 m % | | 3: 30 m % | 6: 70 m % | | | |
| Ex. 17 | LiMn₂O₄: 50 m % | | Formula | Formula | | 1.0 | 82 |
| | LiCoO₂: 50 m % | | 3: 30 m % | 6: 70 m % | | | |

TABLE 2

| | Positive | Polyester-based | | Polyether-based | | | Capacity |
|---|---|---|---|---|---|---|---|
| | electrode active | monomer | | monomer | | VC | maintenance |
| | material | Monomer 1 | Monomer 2 | Monomer 1 | Monomer 2 | (%) | rate (%) |
| Com. | LiMn₂O₄ | | | Formula | | — | 52 |
| Ex. 1 | | | | 6: 100 m % | | | |
| Com. | LiMn₂O₄ | | | Formula | Formula | — | 51 |
| Ex. 2 | | | | 5: 70 m % | 7: 30 m % | | |
| Com. | LiMn₂O₄ | | | Formula | Formula | — | 51 |
| Ex. 3 | | | | 6: 70 m % | 8: 30 m % | | |
| Com. | LiMn₂O₄ | | | Formula | | — | 50 |
| Ex. 4 | | | | 6″: 70 m % | | | |
| Com. | LiMn₂O₄ | | | Formula | | — | 50 |
| Ex. 5 | | | | 6′: 100 m % | | | |
| Com. | LiMn₂O₄ | | | Formula | | 2.0 | 53 |
| Ex. 6 | | | | 6: 100 m % | | | |
| Com. | LiMn₂O₄ | | | | | — | 50 |
| Ex. 7 | | | | | | | |
| Com. | LiMn₂O₄ | | | | | 2.0 | 51 |
| Ex. 8 | | | | | | | |
| Com. | LiMn₂O₄: 50 m % | | | Formula | | — | 60 |
| Ex. 9 | LiCoO₂: 50 m % | | | 6: 70 m % | | | |
| Com. | LiMn₂O₄: 50 m % | | | Formula | | 2.0 | 62 |
| Ex. 10 | LiCoO₂: 50 m % | | | 6: 100 m % | | | |
| Com. | LiMn₂O₄: 50 m % | | | | | — | 61 |
| Ex. 11 | LiCoO₂: 50 m % | | | | | | |
| Com. | LiMn₂O₄: 50 m % | | | | | 2.0 | 62 |
| Ex. 12 | LiCoO₂: 50 m % | | | | | | |
| Ref. | LiCoO₂ | Formula | Formula | | | 2.0 | 79 |
| Ex. 1 | | 1: 70 m % | 3: 30 m % | | | | |
| Ref. | LiCoO₂ | | | Formula | Formula | 2.0 | 79 |
| Ex. 2 | | | | 5: 70 m % | 7: 30 m % | | |
| Ref. | LiCoO₂ | | | | | 2.0 | 81 |
| Ex. 3 | | | | | | | |

In Tables 1 and 2, the unit m % indicates percent by mass. The structures of Formulas 1 to 8 are as follows.
CH₂═CR—CO—(O-A1-CO)ₘ—O—R1 Formula 1
R:H, R1:CH₃, A1:C₂H₅, m=6
   CH₂═CR—CO—(O-A1-CO)ₘ—O—R1 Formula 1′
R:CH₃, R1:CH₃, A1:C₂H₅, m=6
   CH₂═CR—CO—(O-A1-CO)ₘ—CH₂—CH₂—(CO-A1-O)—CO—CR═CH₂ Formula 2
R:CH₃, R1:CH₃, A1:CH₃, m=6 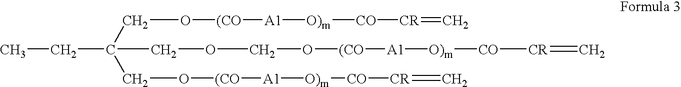
R:H, R1:CH₃, A1:C₂H₅, m=6
Formula 3′ 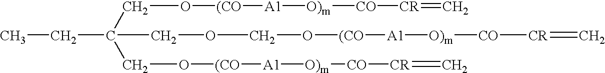
R:CH₃, R1:CH₂, A1:C₂H₅, m=6 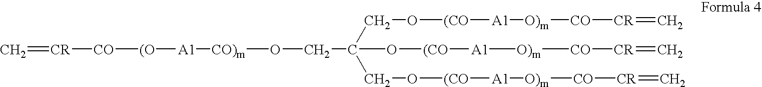
R:H, A1:C₅H₁₀, m=4
   CH₂═CR—CO—O-(A2-O)ₘ—R1 Formula 5
R:H, R1:H, A2:C₃H₅, m=3
   CH₂═CR—CO—O-(A2-O)ₘ—CO—CR═CH₂ Formula 6
R:H, A2:C₃H₅, m=3
   CH₂═CR—CO—O-(A2-O)ₘ—CO—CR═CH₂ Formula 6′
R:H, A2:C₂H₄, m=4
   CH₂═CR—CO—O-(A2-O)ₘ—CO—CR═CH₂ Formula 6″
R:CH₃, A2:C₃H₆, m=4 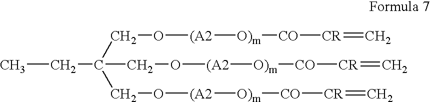
R:H, A2:C₃H₆, m=1 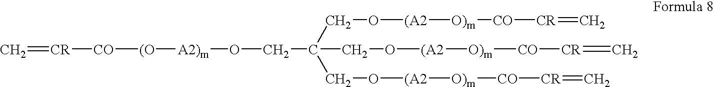
R:H, A2:C₃H₆, m=1

1) The cells of Examples 1 to 5, where only polyester-based monomers were polymerized to obtain polymers (polyester-based polymers), had excellent high-temperature cycle characteristics of 75% to 77%, while the cells of Comparative Examples 1 to 5, where only polyether-based monomers were polymerized to obtain polymers (polyether-based polymers), had high-temperature cycle characteristics of 50% to 52%. The cell of Comparative Example 7, where no monomer for polymerization was contained, had high-temperature cycle characteristics of 50%. Thus, Tables 1 and 2 show that the high-temperature cycle characteristics were much higher with the cells of Examples 1 to 5 than with the cells of Comparative Examples 1 to 5, and 7. Additionally, it has been found that the high-temperature cycle characteristics improved regardless of the kinds of the polyester-based monomers.

This can be considered as follows. The polyether-based polymer does not function to inhibit the dissolution of the manganese into the electrolyte under high temperature conditions. The dissolution is not inhibited, either, in the cell having no monomer for polymerization. The manganese is detached from the positive electrode upon charge and discharge under a high temperature (60° C.), which reduces the cell capacity. Then, the dissolved manganese in the electrolyte deteriorates the polymer electrolyte, thereby further reducing the cell capacity. On the other hand, the polyester-based polymer functions to inhibit the dissolution of the manganese into the electrolyte under high temperature conditions, for some reason yet to be determined. Thus, the high-temperature cycle characteristics are improved.

2) The high-temperature cycle characteristics of the cells of Examples 1 to 5, which used only polyester-based monomers, were 75% to 77%, and those of the cells of Examples 8 to 10, where the polyester-based monomer and the polyether-based monomer were mixed at 3:7 and polymerized to obtain polymers (mixed polymers), were 74% to 75%. Thus, there is no significant difference in the characteristics between the Examples 1 to 5 and Examples 8 to 10. The results of the Examples 10 to 12 show that the values of the high-temperature cycle characteristics decreased as the composition ratio of the polyether-based monomer became higher.

This can be considered as follows. The mixed polymer is a polymerization of monomers including the polyester-based monomer, and the functional group derived from the polyester-based monomer in the mixed polymer functions to inhibit the dissolution of the manganese into the electrolyte under high temperature conditions. As the functional group derived from the polyester-based monomer in the mixed polymer becomes less dominant, the function of inhibiting the manganese dissolution becomes less effective. In view of this, the composition ratio by mass of the polyester-based monomer and the polyether-based monomer is preferably in the range of 100:0 to 10:90, more preferably 100:0 to 20:80, and particularly preferably 100:0 to 30:70.

3) Comparisons of Examples 1 and 5, and of Examples 8, 9, and 10 show that the polyester-based monomer and the polyether-based monomer may include either acrylate or methacrylate (R being a hydrogen atom or a methyl group). In either case, the high-temperature cycle characteristics improve. Additionally, even though the repetition number of the alkylene oxide group is varied, this does not affect the high-temperature cycle characteristics.

Comparisons of Comparative Examples 1, 4, and 5 show that the polyether-based monomer does not function to improve the high-temperature cycle characteristics regardless of the polyether-based monomer including acrylate or methacrylate. Additionally, even though the repetition number of the alkylene oxide group is varied, this does not affect to improve the high-temperature cycle characteristics.

Thus, it has been found that in the above formulas R may be a hydrogen atom or a methyl group, and that the value of m does not affect the high-temperature cycle characteristics.

4) The cells of Examples 5 and 8, which included the functional groups derived from the polyester-based monomer and used positive electrode active materials made of lithium manganese oxide, had high-temperature cycle characteristics of 75% and 77%. The cells of Examples 14 and 16, which had the same compositions as those of the above cells except that the positive electrode active materials were mixtures of lithium manganese oxide and lithium cobalt oxide at 1:1 by mass, had high-temperature cycle characteristics of 80% and 81%. The cells of Examples 14 and 16 had slightly better high-temperature cycle characteristics. The cells of Comparative Examples 1 and 7, which did not include the functional groups derived from the polyester-based monomer and used positive electrode active materials made of lithium manganese oxide, had high-temperature cycle characteristics of 50% and 52%. The cells of Comparative Examples 9 and 11, which had the same compositions as those of the above comparative cells except that the positive electrode active materials were mixtures of lithium manganese oxide and lithium cobalt oxide at 1:1 by mass, had high-temperature cycle characteristics of 60% and 61%. The cells of Comparative Examples 9 and 11 had slightly better high-temperature cycle characteristics.

This can be considered as follows. Though the lithium manganese oxide is problematic in that it is dissolved in the electrolyte under high temperature conditions, its thermal stability is higher than that of the lithium cobalt oxide. The use of a mixture of the lithium manganese and lithium cobalt oxide enables the positive electrode active material to be provided with the excellent performance and capacity of the lithium cobalt oxide and the excellent thermal stability of the lithium manganese oxide. Additionally, as described above, the functional group derived from the polyester-based monomer functions to inhibit the dissolution of the manganese into the electrolyte. These advantages of the three substances combined in the cells of Examples 14 and 16, resulting in higher high-temperature cycle characteristics than those of Examples 5 and 8.

As for Comparative Examples, they did not contain the functional group derived from the polyester-based monomer, and hence could not prevent the dissolution of the manganese into the electrolyte. However, as the composition ratio of the lithium manganese oxide became smaller, the amount of the manganese to be dissolved into the electrolyte reduced. This is why Comparative Examples 9 and 11 had better high-temperature cycle characteristics than those of Comparative Examples 1 and 7.

5) The cells of Examples 6, 7, 13, 15, and 17, which included the functional groups derived from the polyester-based monomer and included vinylene carbonate, had higher high-temperature cycle characteristics by 2 to 5 percentage points than those of the cells of Examples 5, 8, 14, and 16, which had the same compositions as those of the above cells except for including no vinylene carbonate.

This can be considered as follows. The vinylene carbonate reacts to the negative electrode and forms a coating film on the negative electrode surface, and thus functions to inhibit the reaction of the non-aqueous solvent and the negative electrode. However, the vinylene carbonate has a carbon-carbon double bond and hence can be incorporated into the polymer molecule upon polymerization. Even so, it is considered that the vinylene carbonate still functions to inhibit the reaction of the non-aqueous solvent and the negative electrode.

6) There was no significant difference between the high-temperature cycle characteristics of the cells of Comparative Examples 6, 8, 10, and 12, which did not include the functional groups derived from the polyester-based monomer and included vinylene carbonate, and the cells of Comparative Examples 1, 7, 9, and 11, which had the same compositions as those of the above comparative cells except for including no vinylene carbonate.

This can be considered as follows. The cells of Comparative Examples did not include the functional groups derived from the polyester-based monomer and hence could not inhibit the dissolution of the manganese into the electrolyte. Additionally, the vinylene carbonate does not form a coating film on the positive electrode, which includes the lithium manganese oxide, but on the negative electrode. The addition of the vinylene carbonate therefore cannot inhibit a decrease in the cell capacity caused by the dissolution of the manganese included in the positive electrode into the electrolyte. This is why the high-temperature cycle characteristics were poor in the above Comparative Examples.

7) The cell of Example 7, which had the positive electrode active material made of lithium manganese oxide and included 2 mass % of vinylene carbonate, had high-temperature cycle characteristics of 82%. The cell of Reference Example 1, which had the same polymer composition as that of the cell of Example 7 and used only lithium cobalt oxide as the positive electrode active material and included 2 mass % of vinylene carbonate, had high-temperature cycle characteristics of 79%. The cell of Example 7 had slightly better high-temperature cycle characteristics.

This can be considered as follows. Though the lithium manganese oxide is problematic in that it is dissolved in the electrolyte under high temperature conditions, its thermal stability is higher than that of the lithium cobalt oxide. Additionally, as described above, the functional group derived from the polyester-based monomer functions to inhibit the dissolution of the manganese into the electrolyte. These advantages of the two substances combined in the cell of Example 6, resulting in higher high-temperature cycle characteristics than those of Reference Example 1.

8) The high-temperature cycle characteristics of the cell of Reference Example 1, which used lithium cobalt oxide as the positive electrode active material and used a polyester-based polymer, the cell of Reference Example 2, which used lithium cobalt oxide as the positive electrode active material and used a polyether-based polymer, and the cell of Reference Example 3, which used lithium cobalt oxide as the positive electrode active material and included no polymer component, were 79% to 80%. There was no significant difference in the high-temperature cycle characteristics. This indicates that when lithium cobalt oxide is used as the positive electrode active material the high-temperature cycle characteristics are not relative to the kinds of polymer components or absence thereof.

This can be considered as follows. Unlike the lithium manganese oxide, the lithium cobalt oxide is not dissolved into the electrolyte under high temperature conditions. Even though there is no polyester-based polymer, the high-temperature cycle characteristics do not decrease.

Supplementary Remarks

1) While in the above Examples vinylene carbonate was used as the vinylene carbonate derivative, methyl vinylene carbonate, ethyl vinylene carbonate, or the like may be used. If, however, the added amount of the vinylene carbonate derivative is excessive, the resistance of the coating film formed on the negative electrode surface increases, which decreases cell performance. If the added amount of the vinylene carbonate derivative is too small, the desired effects will not be obtained. In view of this, the added amount of the vinylene carbonate derivative is preferably 0.01 to 10 parts by mass, more preferably 0.05 to 5 parts by mass per 100 parts by mass of the polymer electrolyte.

2) While in the above Examples ethylene carbonate, propylene carbonate, and diethyl carbonate were used as the non-aqueous solvent, it will be appreciated that there are alternatives. For instance, carbonates such as dimethyl carbonate and butylene carbonate, lactones such as γ-butyrolactone and γ-valerolactone, ethers such as γ-dimethoxyethane, tetrahydrofuran, and 1,4-dioxane, ketones such as cyclohexanone, and esters such as ethyl formate and methyl acetate may be used alone or in combination. Preferred among these are carbonates, lactones, ethers, and ketones. Carbonates are particularly preferred.

3) While in the above Examples the positive electrode active material was made of spinel-type lithium manganese oxide (LiMn₂O₄) or a mixture of spinel-type lithium manganese oxide and lithium cobalt oxide (LiCoO₂), a mixture of lithium manganese oxide and other lithium-containing transition metal oxides may be used such as lithium nickel oxide (LiNiO₂), lithium metal oxide (LiFeO₂), and the like. Also contemplated are lithium-containing manganese oxides that have another metal element in the crystal lattice. The composition ratio of the lithium manganese oxide is preferably 10% to 100% by mass of the entire positive electrode active material.

4) While in the above Examples graphite was used for the negative electrode active material, it may be made of carbon black, coke, glass carbon, carbon fiber, or carbonaceous substances such as calcined structures of the foregoing. Also contemplated are lithium, lithium alloys, metal oxides capable of intercalating and deintercalating lithium, silicon, silicon compounds, and the like.

5) As the electrolyte salt, LiN(C₂F₅SO₂)₂, LiN(CF₃SO₂)₂, LiClO₄, LiPF₆, or LiBF₄ may be used alone, or two or more of the foregoing may be mixed. LiPF₆, and LiBF₄ are particularly preferred. The amount thereof dissolved in the non-aqueous solvent is preferably 0.5 to 2.0 mole/liter.

6) The polyester-based monomer and the polyether-based monomer are not limited by the functional groups and the repetition numbers specified in the above Examples; in Formulas 1 to 8 above, R may be a hydrogen atom or a methyl group, R1 may be a methyl group or an ethyl group, A1 may be an alkylene group (straight chained or branched) represented by CₙHₙ with two or more carbon atoms, A2 may be an alkylene group (straight chained or branched) represented by CₚHₚ with two or more carbon atoms, and m may be an integer of 1 or greater. It should be noted, however, that Formulas 1 to 8 above are examples of the polyester-based monomer and the polyether-based monomer and that a different structure may be employed.

7) While in the above Examples the prepolymer was dissolved at a ratio of 1 part by mass per 15 parts by mass of the electrolyte solution (6.67 parts by mass per 100 parts by mass of the electrolyte solution), the ratio is not limited to this value and may be in the range of 1 to 30 parts by mass.

8) While in the above Examples t-butyl peroxy pivalate was blended at 5000 ppm as the polymerization initiator, other organic peroxides may be used such as diacyl peroxide, peroxy ester, dialkyl peroxide, peroxy ketal, peroxy dicarbonate, peroxy monocarbonate, and t-hexyl peroxy pivalate. Additionally, the composition ratio is not limited to 5000 ppm. Further, the polymerization initiator is not essential for polymerization, which can also be performed by heating, UV rays radiation, or the like.

As has been described above, the present invention provides a non-aqueous electrolyte cell excellent in high-temperature cycle characteristics and high-temperature stability at low cost, and hence has considerable industrial applicability.

1. A non-aqueous electrolyte cell comprising:
a positive electrode;
a negative electrode; and
a polymer electrolyte, wherein:
the positive electrode includes lithium manganese oxide as an active material;
the polymer electrolyte is a polymerization of a prepolymer included in a prepolymer electrolyte, the prepolymer electrolyte including a non-aqueous solvent, an electrolyte salt, and the prepolymer; and
the prepolymer includes polyester acrylate and/or polyester methacrylate.

2. The non-aqueous electrolyte cell according to claim 1, wherein the prepolymer electrolyte further includes a vinylene carbonate derivative.

3. The non-aqueous electrolyte cell according to claim 1, wherein the prepolymer includes polyether acrylate and/or polyether methacrylate.

4. The non-aqueous electrolyte cell according to claim 2, wherein the prepolymer includes polyether acrylate and/or polyether methacrylate.
